(19) United States
(12) Patent Application Publication
(10) Pub. No.: US 2025/0086426 A1
(43) Pub. Date: Mar. 13, 2025

(54) QUANTIZATION-AWARE FEDERATED TRAINING TO ADDRESS EDGE DEVICES HARDWARE CAPABILITIES

(71) Applicant: QUALCOMM Incorporated, San Diego, CA (US)

(72) Inventors: An CHEN, San Diego, CA (US); Vijaya Datta MAYYURI, San Diego, CA (US)

(21) Appl. No.: 18/465,034

(22) Filed: Sep. 11, 2023

(51) Int. Cl. G06N 3/045; G06N 3/0495

(52) U.S. Cl. CPC G06N 3/045; G06N 3/0495

(57) ABSTRACT

A processor-implemented method for quantization-aware federated training includes quantizing, by a server, a global model. The global model is quantized at multiple different quantization levels for each of one or more subnetwork models to generate one or more quantized subnetwork models. The one or more subnetwork models are assigned to one or more of multiple devices according to device processing capabilities. The server distributes to one or more of the multiple devices, a quantized subnetwork model. The server receives a model update from the one or more devices based on local data. The server generates an updated global model according to an aggregation function based on the model update from each of the one or more devices.

### FIELD OF THE DISCLOSURE

Aspects of the present disclosure generally relate to neural networks and more particularly to quantization-aware federated training to address edge devices hardware capabilities.

### BACKGROUND

Federated learning is an approach for collaborative training of neural networks across multiple edge devices without gathering data at a central location. Because of the decentralized training, wherein raw data is not shared by the edge devices, federated learning is beneficial for applications in which privacy is a significant factor. Federated learning aims to address the differential privacy, continual learning, and personalization by having the edge (or end) devices perform the training locally using the data collected and transmit only the weight updates rather than the raw data.

Although federated learning frameworks may address these fundamental issues, performing training on the device is challenging and may be taxing in terms of memory and compute resources. As a result, some resource restricted devices may be hindered from participating in the federated learning process. Such limitations on participation may result in model bias and decreased model performance.

### SUMMARY

The present disclosure is set forth in the independent claims, respectively. Some aspects of the disclosure are described in the dependent claims.

In various aspects of the present disclosure, a processor-implemented method includes quantizing, by a server, a global model. The global model is quantized at multiple different quantization levels for each of one or more subnetwork models to generate one or more quantized subnetwork models. The one or more subnetwork models are assigned to one or more of multiple devices according to device processing capabilities. The processor-implemented method also includes distributing, by the server, to at least one device of the multiple devices, a quantized subnetwork model. The processor-implemented method further includes receiving, by the server, a model update from the at least one device based on local data. The processor-implemented method further still includes generating, by the server, an updated global model according to an aggregation function based on the model update from each of the at least one device.

Some aspects of the present disclosure are directed to an apparatus having a at least one memory and one or more processors coupled to the at least one memory. The processor(s) is configured to quantize, by a server, a global model. The global model is quantized at multiple different quantization levels for each of one or more subnetwork models to generate one or more quantized subnetwork models. The one or more subnetwork models are assigned to one or more of multiple devices according to device processing capabilities. The processor(s) is also configured to distribute, by the server, to at least one device of the multiple devices, a quantized subnetwork model. The processor(s) is further configured to receive, by the server, a model update from the at least one device based on local data. The processor(s) is further still configured to includes means for generate, by the server, an updated global model according to an aggregation function based on the model update from each of the at least one device.

In various aspect of the present disclosure, a processor-implemented method includes receiving, by a device, from a server, a quantized subnetwork model. The quantized subnetwork model corresponds to a global model. The global model is quantized at multiple different quantization levels for each of one or more subnetwork models to generate one or more quantized subnetwork models. The one or more subnetwork models is assigned to one or more of multiple devices according to device processing capabilities. The processor-implemented method also includes generating, by the device, a model update for the quantized subnetwork model based on local data. The processor-implemented method further includes transmitting, by the device, the model update to the server, the server generating an updated global model based on the model update.

Some aspects of the present disclosure are directed to an apparatus having at least one memory and one or more processors coupled to the at least one memory. The processor(s) is configured to receive, by a device, from a server, a quantized subnetwork model. The quantized subnetwork model corresponds to a global model. The global model is quantized at multiple different quantization levels for each of one or more subnetwork models to generate one or more quantized subnetwork models. The one or more subnetwork models are assigned to one or more of multiple devices according to device processing capabilities. The processor(s) is also configured to generate, by the device, a model update for the quantized subnetwork model based on local data. The processor(s) is further configured to transmit, by the device, the model update to the server, the server generating an updated global model based on the model update.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 is a high-level block diagram illustrating an example system for hardware-aware federated learning, in accordance with aspects of the present disclosure.

FIGS. 6A and 6B are flow diagrams illustrating example processes for hardware-aware federated learning, in accordance with aspects of the present disclosure.

FIG. 7 is a block diagram illustrating an example process for quantization-aware federated training, in accordance with various aspects of the present disclosure.

FIG. 8 is a diagram illustrating example pseudocode for server quantization-aware federated training, in accordance with various aspects of the present disclosure.

FIG. 9 is a block diagram illustrating an example process for collaborative quantization-aware federated training, in accordance with various aspects of the present disclosure.

FIG. 10 is a diagram illustrating example pseudocode for collaborative quantization-aware federated training, in accordance with various aspects of the present disclosure.

FIG. 11 is a flow diagram illustrating an example processor-implemented method for server-based quantization-aware federated training, according to various aspects of the present disclosure.

FIG. 12 is a flow diagram illustrating an example processor-implemented method for collaborative quantization-aware federated training, according to various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Federated learning is a decentralized form of machine learning, in which one or more local clients (e.g., end devices) collaboratively train a statistical model under the orchestration of a central device (e.g., a server, serving cell, parameter server, etc.), while keeping the training data localized and maintaining privacy of the local client data. That is, machine learning models, such as deep neural networks, are trained on raw data collected from multiple local datasets contained in the end devices without receiving or accessing the raw data.

Stated another way, federated learning enables users (or end devices) to train a machine learning model in a distributed fashion. Each end device may use their local dataset to train a local model and then send model updates to a central server. For example, at each round of a federated learning process, a parameter server may select a number of users and send a copy of a global machine learning model to the selected users. Each local training iteration of the federated learning process may be referred to as an epoch and each communication round with the server may be referred to as a communication round. Each end device computes parameters of the model with its own dataset and feeds back a corresponding update (e.g., weight updates) to the parameter server. The parameter server aggregates all the end device updates and determines an update for the global model by, for example, averaging the aggregated end device updates or other techniques. The parameter server broadcasts the new parameters of the global model to the selected users at the next round of the federated learning process. Because of the non-transmission of localized data, federated learning is beneficial for applications in which privacy is a factor.

As described, federated learning involves learning a server model, such as a neural network, with matrix tensor parameters w with a data set of P data points [symbol] ={(x₁, y₁), . . . , (xₚ, yₚ)} that is distributed across end devices N, where, for instance, [symbol] = [symbol] ᵢ ∪ . . . ∪ [symbol] _{N} without accessing the device-specific data sets directly. By defining a loss function [symbol] _{N} ( [symbol] _{N}; w) per end-device, the total security risk may be written as:

$$arg {min}_{w} {\sum }_{N = 1}^{N} \frac{{N}_{N}}{P} {ℒ}_{N} ( {𝒟}_{N} ; w ) , \qquad ( 1 )$$

$${ℒ}_{N} ( {𝒟}_{N} ; w ) := \frac{1}{{N}_{N}} {\sum }_{i = 1}^{{N}_{N}} L ( {𝒟}_{N i} ; w ) . \qquad ( 2 )$$

This objective corresponds to empirical risk minimization over the joint data set [symbol] with a loss L(⋅) for each data point. In federated learning, it is beneficial to reduce the communication costs. As such, multiple gradient updates for weight parameters w in the inner optimization of the objective may be performed for each of the devices N, thus obtaining local models with weight parameters w_{N}. The multiple gradient updates may be referred to as local epochs, such as an amount of data that passes through the entire local data set, with an abbreviation of E. Each end device may then communicate an update corresponding to the local weight ws to the server. In turn, the server updates the global model at round t, for example, by averaging the parameters of the local model

$${w}^{{}_{t}} = {\sum }_{N} \frac{{N}_{N}}{P} {w}_{N}^{t} .$$

Although federated learning frameworks may address these fundamental issues, performing training on the device is challenging and may be taxing in terms of memory and compute resources.

Because of the demand on the memory and processing capabilities, many devices may not be able to participate in federated learning training due to their hardware capabilities. The edge devices in federated learning may be mobile devices (“user equipment (UEs)”) that may have inherent differences in capabilities (or characteristics). For example, hardware capabilities for different UEs may include a number and type of processors, and an amount and type (e.g., speed) of memory. Dynamic hardware capabilities may include available or projected power (e.g., battery power), available or projected compute resources (e.g., based on concurrently running applications), and available or projected communication bandwidth. Thus, hardware capabilities may be dynamic. Moreover, the same UE may be capable of training different (types of) models at different times. The hardware limitations may hinder devices with lower capabilities to reap the benefits of federated learning. In addition, the hardware limitations may result in bias in the model because some users may be unable to utilize federated learning due to the limited hardware capable devices. Such limitations may result in poor model performance (e.g., incorrect classification).

To address these and other challenges, aspects of the present disclosure are directed to quantization-aware federated training.

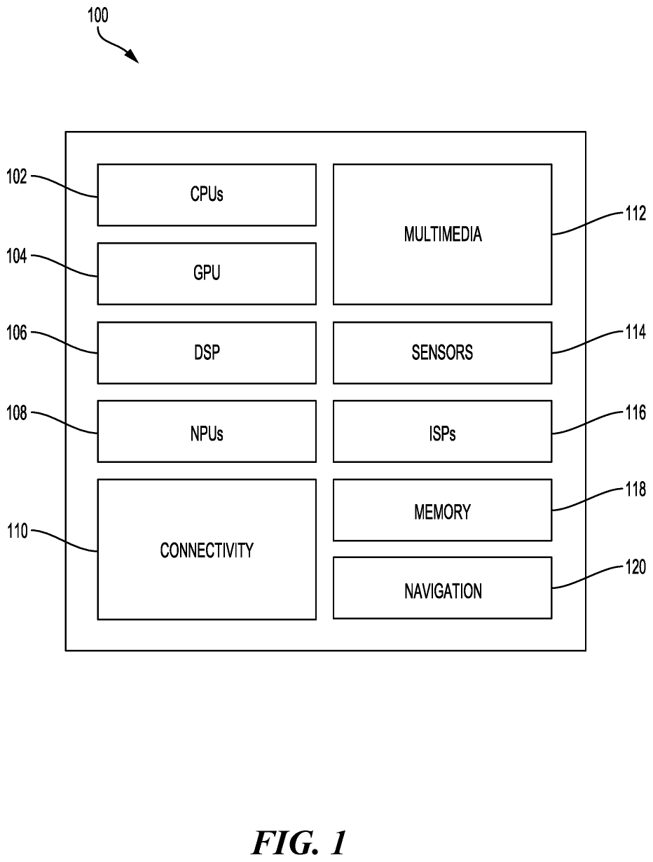

FIG. 1 illustrates an example implementation of a system-on-a-chip (SOC) 100, which may include a central processing unit (CPU) 102 or a multi-core CPU configured for quantization-aware federated training in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to quantize, by a server, a global model. The global model is quantized at multiple different quantization levels for each of one or more subnetwork models to generate one or more quantized subnetwork models. The one or more subnetwork models are assigned to one or more of multiple devices according to device processing capabilities. The instructions loaded into the CPU 102 may also comprise code to distribute, by the server, to at least one device of the multiple devices, a quantized subnetwork model. The instructions loaded into the CPU 102 may additionally comprise code to receive, by the server, a model update from the at least one device based on local data. The instructions loaded into the CPU 102 may also comprise code to generate, by the server, an updated global model according to an aggregation function based on the model update from each of the at least one device.

In some aspects, the instructions loaded into the CPU 102 may comprise code to receive, by a device, from a server, a quantized subnetwork model. The quantized subnetwork model corresponds to a global model. The global model is quantized at multiple different quantization level for each of one or more subnetwork models to generate one or more quantized subnetwork models. The one or more subnetwork models are assigned to one or more of multiple devices according to device processing capabilities. The instructions loaded into the CPU 102 may also comprise code to generate, by the device, a model update for the quantized subnetwork model based on local data. The instructions loaded into the CPU 102 may additionally comprise code to transmit, by the device, the model update to the server, the server generating an updated global model based on the model update.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

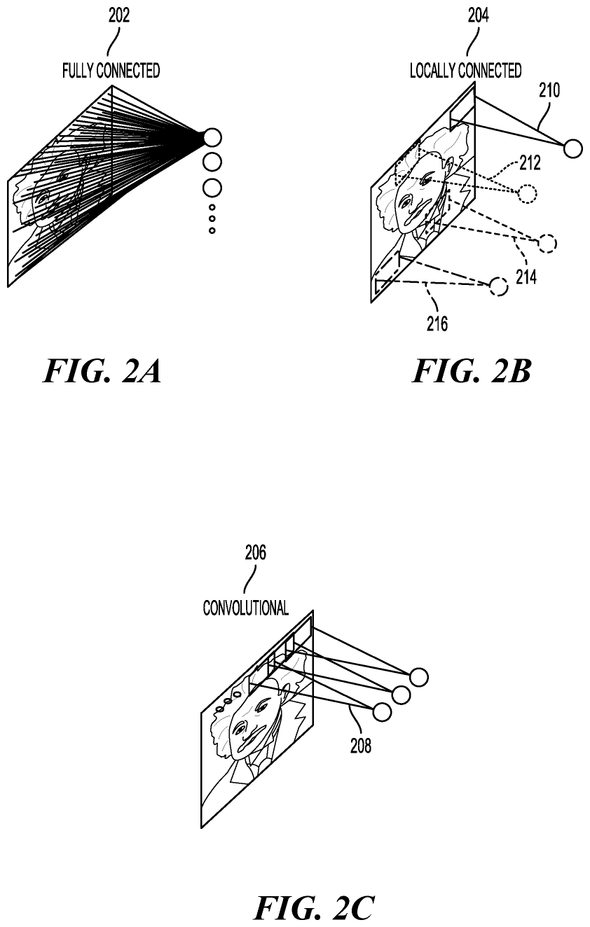

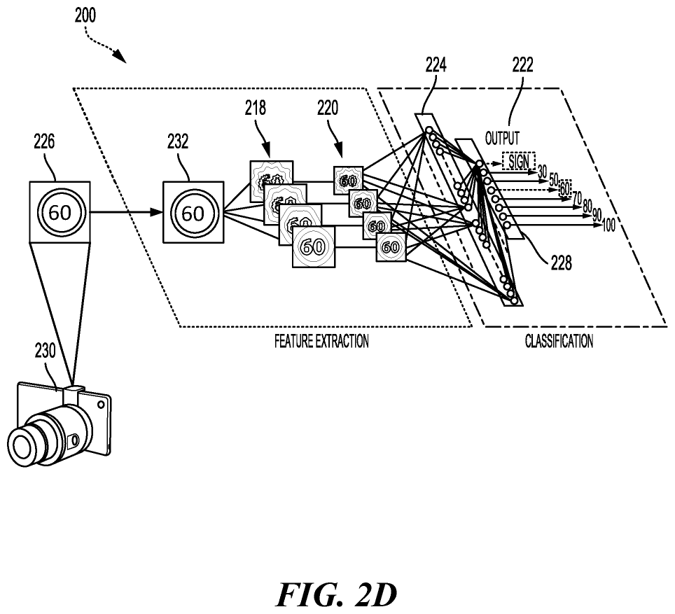

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

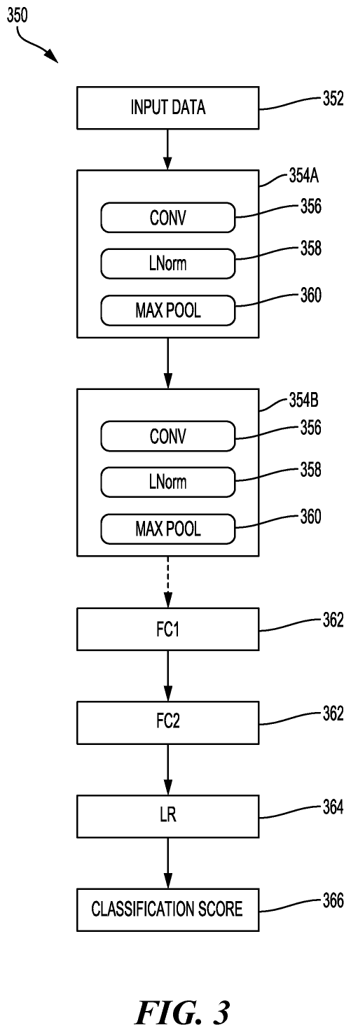

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

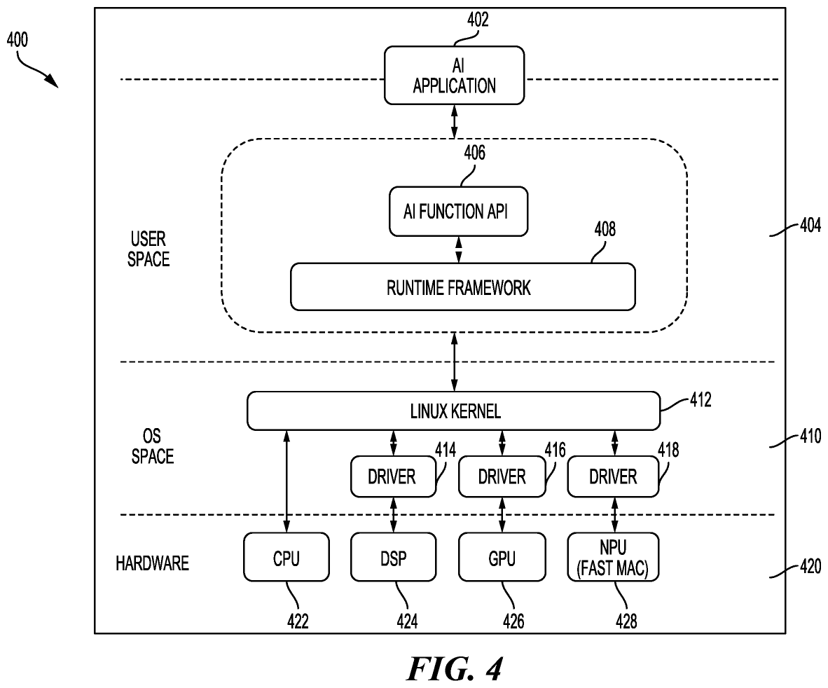

The parallel filter banks, for example, of a deep convolutional network may be loaded on a CPU 102 or GPU 104 of an SOC 100 (e.g., FIG. 4) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support quantization-aware federate training for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Linux Kernel 412, running on the SOC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

According to certain aspects of the present disclosure, each of the fully connected layers 362 may be configured to determine parameters of the model based upon desired one or more functional features of the model, and develop the one or more functional features towards the desired functional features as the determined parameters are further adapted, tuned, and updated.

As indicated above, FIGS. 1-4 are provided as examples. Other examples may differ from what is described with respect to FIGS. 1-4.

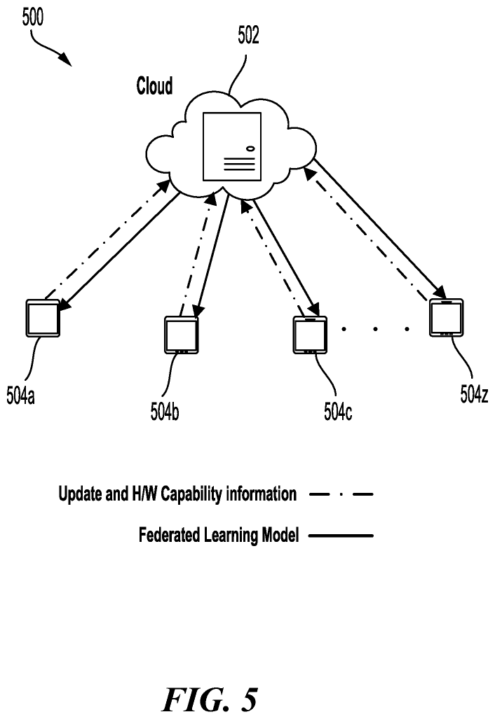

FIG. 5 is a high-level block diagram illustrating an example system 500 for hardware-aware federated learning, in accordance with aspects of the present disclosure. Referring to FIG. 5, the system 500 includes a server 502 for managing a federated learning model. The system 500 also includes multiple end devices 504a-z. The end devices 504a-z may each comprise a mobile communication device such as a smartphone, a tablet, an electric vehicle, or an Internet of Things (IoT) device, for example. Each of the end devices (e.g., 504a-z) may have a different hardware configuration, which may include dynamic hardware capabilities. For instance, some end devices (e.g., 504a) may be configured with graphics processing units (GPUs), neural processing units (NPUs), digital signal processors (DSPs) or may have different memory configurations. Accordingly, each of the end devices (e.g., 504a-z) may have different capabilities for operating a federated learning model or performing on-device training of the federated learning model. In accordance with aspects of the present disclosure, each of the end devices (e.g., 504a-z) may be configured to evaluate the device's current hardware capabilities. The evaluation of current hardware capabilities, for example, may be based on physical hardware configuration (e.g., GPU, NPU, etc.) and processing capabilities. In some aspects, the current hardware capabilities may be evaluated or determined based on the current workload of the end device (e.g., 504a-z) or other performance metrics. The end devices 504a-z may send an indication of their current hardware capabilities. In turn, the server 502 may adapt an initial or full featured federated learning model for each end device (e.g., 504a-z), according to the current hardware capabilities. For instance, the server 502 may compress a full featured federated learning model (e.g., via one or more of pruning, quantization, or other model compression techniques). The compressed model may be sent to the particular end device (e.g., 504a-z).

The end device (e.g., 504a-z) may continue to monitor the current hardware capabilities and may update the server 502 so that the server 502 may continue to provide a model commensurate with the current hardware capabilities. In doing so, the server 502 may provide the best level of the federated learning model that the end device (e.g., 504a-z) may accommodate. That is, server 502 may configure a federated learning model that may run on the end device with reduced or in some aspect no degradation in model performance. As such, model latency and power consumption may beneficially be reduced. Thus, user experience and enjoyment while executing the model in the background may also be improved.

Additionally, the federated learning model may be improved because more end devices may be able to participate in the federated learning process. Each of the end devices (e.g., 504a-z) may individually re-train the model on-device based on locally collected data. Each end device (e.g., 504a-z) determines model updates (e.g., weight updates) and sends such updates to the server 502. In some aspects, an end device may select a frequency at which the model updates (e.g., weight updates) are provided to the server. The frequency may be based on the current hardware capabilities. In one example, a powerful smartphone may provide weight update when it is being charged or does not have a heavy workload. In another example, an end device with less hardware capabilities such as an IoT device or other battery-powered device for which battery resource is more of a concern, the frequency of updates may be adapted to keep the device running longer. The server 502, in turn, jointly-trains the federated learning model based on the updates received from the end devices (e.g., 504a-z).

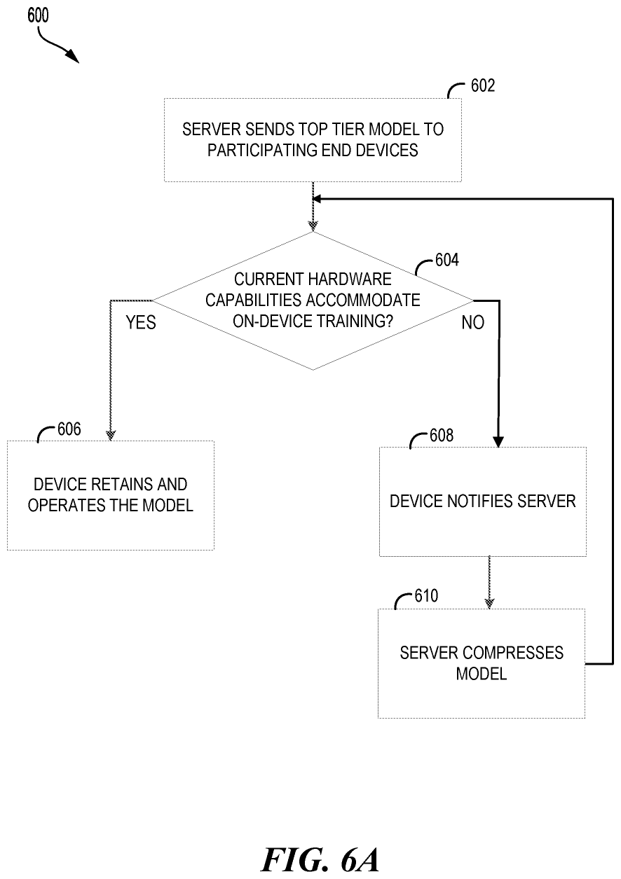

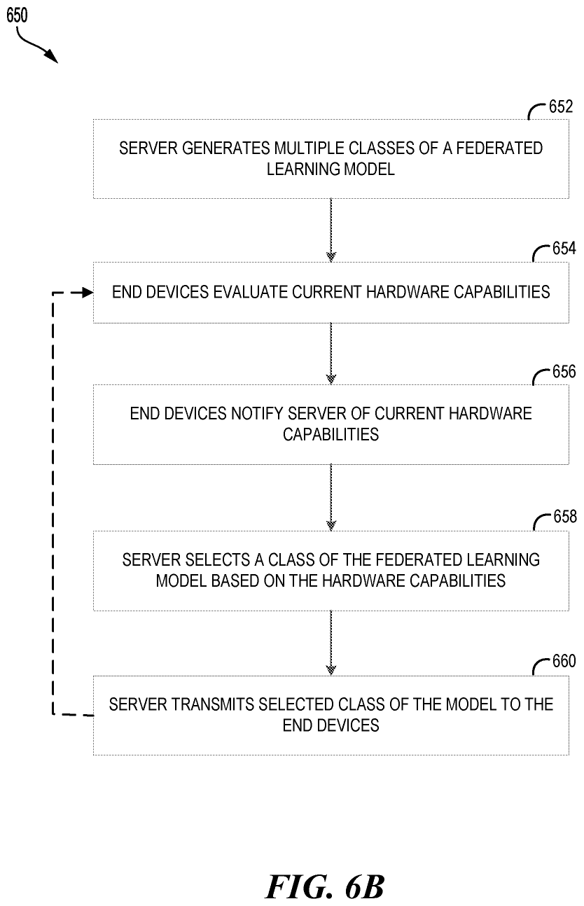

FIGS. 6A and 6B are flow diagrams illustrating example processes 600 and 650 for hardware-aware federated learning, in accordance with aspects of the present disclosure. Referring to FIG. 6A, at block 602, a server (e.g., 502 shown in FIG. 5) may send a federated learning model to a set of participating end devices (e.g., 504a-z shown in FIG. 5). The federated learning model may, for example, be an artificial neural network (e.g., 350 shown in FIG. 3). The federated learning model may be a top tier model (e.g., full featured model). In various aspects, the federated learning model may be generated based on a top-level of hardware capabilities of the participating end devices. For example, the server may survey the participating end devices and may determine the top-level hardware capabilities. The server may then generate the top tier model based on the top-level hardware capabilities.

Each of the participating end devices may evaluate its current hardware capabilities. At block 604, the participating end devices may determine whether the current hardware capabilities may accommodate on-device training. In various aspects, the accommodation of on-device training may be evaluated based on certain key performance indicators (KPIs). KPIs may for instance, include inferences per second (IPS), double data rate read/write bandwidth, power consumption, memory footprint or other performance indicators. In a first example, a threshold may be applied to determine whether current hardware capabilities may accommodate on-device training (e.g., >50,000 IPS). In a second example, the server may advertise a set of models and a set of hardware specifications to run each model. As such, an end device if its current hardware capabilities comply with or meet the specifications for the advertised models and in some aspects, may determine a model best suited for its current hardware capabilities.

The end devices may determine the current hardware capabilities based on a physical hardware configuration. Additionally, in some aspects, the current hardware capabilities may be determined based on the current workload, an estimated time to completion, or other performance metrics. If the current hardware capabilities accommodate on-device training, at block 606, the device retains the model (e.g., top tier model). The device may operate the model on locally-collected data. Additionally, the device may conduct on-device training based on the locally-collected data. In turn, the device may send weight updates calculated during the on-device training to the server (not shown).

If the device (e.g., 504b) determines that the current hardware capabilities may not accommodate on-device training, then at block 608, the device may send a notification to the server. The notification may include an indication of the current hardware capabilities of the device. Alternatively, in some aspects, the end device may also indicate that its current hardware capabilities may accommodate a more complex model than the models advertised.

In response to the notification, at block 610, the server may adapt the model to adjust the model complexity. For example, in some aspects, the server may compress the top tier model. The server may compress the top tier model using one or more of pruning, quantization or other compression or model personalization techniques. The server may send the adapted model to the end device.

Thereafter, the process 600 may return to block 604 to evaluate whether the current hardware capabilities may accommodate on-device training based on the adapted model.

In this way, the process 600 may be iteratively applied until each device can successfully train the federated learning model on-device.

However, as the current hardware capabilities may vary, for example, based on hardware configuration changes or workload changes, in some aspects, the process may continually or periodically be repeated. In this way, the model complexity may be updated, and in some aspects, optimized based on the current hardware capabilities of each device.

In other aspects (not shown), the server sends a characterization of the model to a set of participating end devices, instead of the whole model. In these aspects, the end devices can determine, based on the characterization, if the end devices are capable of participating in the training rounds for the model. If so, the end devices message the server accordingly, which then sends the initial model to the capable end devices.

Referring to FIG. 6B, at block 652, the process 650 provides that a server may generate multiple classes or tiers of a federated learning model. The multiple classes or tiers of the federated learning model may have a different level of model complexity. The multiple classes or tiers of the federated learning model may be based on different hardware capabilities of the participating end devices. For example, the multiple classes of the federated learning model may be based on different dimensions such as hardware processors (e.g., GPU, NPU, DSP, etc.), floating-point weights, fixed point weight quantization, edge pruning implemented, or the like.

At block 654, the end devices may determine current hardware capabilities. For instance, an end device may determine whether the current hardware capabilities may accommodate on-device training. In various aspects, the current hardware capabilities may be determined based on the physical hardware configuration. Additionally, in some aspects, the current hardware capabilities may also be determined based on workload (e.g., applications being executed), estimated workload completion, or other performance metrics, for example. In still other aspects, the server may send the participating devices (e.g., end devices 504z) an evaluation function to discover their hardware capabilities. The evaluation function may be a program executed on the end devices. The output of the program captures the hardware capabilities of the end devices at a given time, or over a duration of time. The end devices report the hardware capabilities back to the server. The end devices may use the evaluation function from time to time (periodically or event-driven) and may notify the server to negotiate a new model based on the current hardware capabilities.

At block 656, the end devices (e.g., 504z) may notify the server of its current hardware capabilities. For example, the end devices may report the hardware capabilities back to the server based on output of the evaluation function. At block 658, the server may select a class or tier of the federated learning model for each end device based on the current hardware capabilities. The selected class or model may be an estimate of a model for which the end device's current hardware capabilities may accommodate on-device training. At block 660, the server may transmit the selected class of the model to the end devices.

Each end device may then conduct on-device training based on the received model. Accordingly, an end device may collect data and operate the local model, each of the participating devices may be re-trained (e.g., according to a loss function) on-device, producing a local model update (e.g., weight updates). In turn, the device may send weight updates determined during the on-device training to the server. Furthermore, the server may update each of the classes or tiers of the federated learning model based on the weight updates for the end devices (e.g., 504a-z). For instance, the server may update the weights for each class of the federated learning models, using a weight update methodology (e.g., weight averaging). The server may also send the updated model classes to the respective devices.

The process may return to block 654 to repeat the evaluation of the current hardware capabilities. Accordingly, the server may provide a class of the model to the end devices responsive to any changes in the current hardware capabilities. In some aspects, an end device may initiate a model query to the server. For instance, where there is a change in its current hardware capabilities (e.g., change of the physical hardware configuration or a change in workload), the end device may request that the server select a new model based on the current hardware capabilities in view of the change. In one example, an end device may be able to handle a more complex model because the outstanding processes running on it previously have completed. On the other hand, the device may have new processes that are competing for hardware resources and thus may be able to accommodate a less complex model.

In various aspects, an end device may also train multiple classes or tiers of the jointly trained ANN. For instance, where the end device has substantial processing capabilities (e.g., hardware configuration with numerous processing resources) and the current workload is below a threshold value (e.g., less than ten percent of processing capacity), the end device, similar to the server, may train multiple classes or tiers of the jointly trained ANN. Additionally, the end device may also provide such classes or tiers of the jointly trained ANN to the server or other end devices, for example. For instance, when the device is charging overnight, with few or no other applications competing for the end device resources, the end device may conduct multiple model trainings without impacting the device performance and user experience.

As such, the dynamic approach described may enable the end devices (e.g., 504a-z of FIG. 5) to continue to participate and reap the benefits of the federated learning framework regardless of the processes competing for the hardware resources on the devices. Moreover, the federated learning training may benefit by increasing the number of devices that may contribute weight updates and thus improve the federated learning model.

Aspects of the present disclosure are directed to quantization-aware federated training. Weight updates may be generated to take advantage of hardware-aware federated machine learning. In various aspects of the present disclosure, a server may perform the quantization-aware federated training. In some aspects, devices and the server may jointly perform the quantization-aware federated training.

In various aspects of the present disclosure, one or more subnetwork models may be generated by using techniques such as once-for-all-network or by hand-crafting the subnetwork models through pruning to fit the hardware capabilities of a set of the devices participating in the federated machine learning.

The parameter Sm, {m=1 . . . K} is a set of subnetwork models sorted from a smallest size to a largest size. Smaller subnetwork models may be assigned to devices having less hardware capabilities according to the following criteria, for example, (1) devices may be assigned the largest subnetwork model that may fit into the memory footprint of the device and based on the processing capabilities of the device, or (2) devices may be assigned the largest subnetwork model that upper bounds the training time on the device. Furthermore, smaller subnetwork models may be contained within a larger subnetwork model. For instance, S1 may be a subset of S2, S2 may be a subset of S3, etc.

Given a server and a set of N devices i∈[1, N], the server may have collected data D, and each device i may have a local dataset Dᵢ. The server may independently train, or jointly-train with the devices, an aggregated global model θ. The local models θⁱ of the devices may be trained given fixed quantization levels qᵢ, where qᵢ represents the quantization level, by minimizing the summation loss:

$${θ}^{{i}^{*}} = arg {min}_{{\{ {θ}^{i} \}}_{i ϵ [ 1 , N ]}} [ {\sum }_{i ϵ N} L ( Q ( {θ}^{i} , {q}_{i} ) , {D}_{i} ) ] + L ( θ , D ) , \qquad ( 3 )$$

where L is a loss function, Q is a model quantization function, and the local models θⁱ can have different levels of quantization qᵢ. The quantization function Q may quantize the vector θ element-wise and returns the sign of θ and ∥θ∥₂ rounded to an endpoint of is encompassing interval.

In Equation 3, the first term [Σ_{i∈N}L(Q(θⁱ, qᵢ), Dᵢ)] is the loss across devices and the second term L(θ, D) is the loss of the aggregated global model θ=G({θⁱ}) on the server's data D.

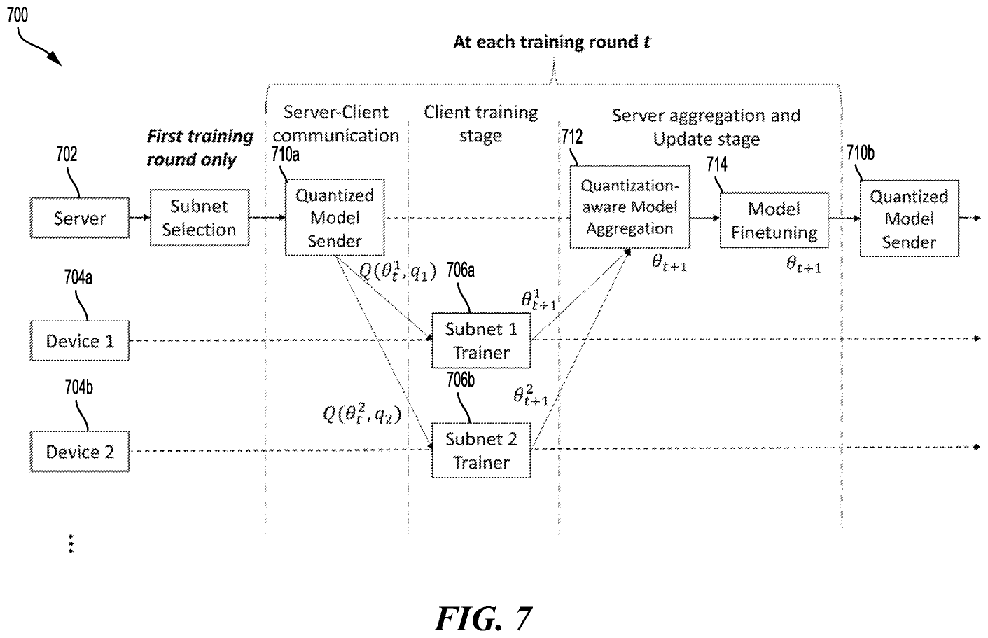

FIG. 7 is a block diagram illustrating an example process 700 for quantization-aware federated training, in accordance with various aspects of the present disclosure. Referring to FIG. 7, the example process 700 includes a server 702, a first device (device 1 704a) and a second device (device 2 704b). For ease of illustration, two devices are shown. However, the present disclosure is not so limiting, and any number of devices may be included.

The server 702 may select one or more subnetwork models (e.g., 706a, 706b) to train. At each training iteration (e.g., training round t), the server 702 may transmit quantized subnetwork models to the respective devices (e.g., 704a, 704b). That is, the server 702 may generate a quantized global model for each device (e.g., 704a, 704b) in which the global model is quantized at a quantization level according to the subnetwork model. As such, the server 702 may distribute the quantized global model Q(θₜ¹, q₁) to device 1 704a assigned subnetwork model 1 and the quantized global model Q(θₜ², q₂) to device 2 704b assigned subnetwork model 2 (at block 710a).

The device 1 704a and device 2 704b may respectively train local quantized subnetwork models (e.g., θₜ₊₁¹, θₜ₊₁²) for subnetwork 1 (at block 706a) and subnetwork 2 (at block 706b). The device 1 704a and the device 2 704b may independently train and update the local subnetwork models using the respective local data by minimizing the loss function given by:

$${θ}_{t + 1}^{i} = arg {min}_{{θ}^{i}} L ( {θ}^{i} , {D}_{i} ) . \qquad ( 4 )$$

The device 1 704a and the device 2 704b may transmit respective updated subnetwork models (e.g., weight updates) to the server 702. In the example of FIG. 7, the device 1 704a and the device 2 704b may not perform quantization on the updated subnetwork models.

In turn, the server 702 may aggregate the updated subnetwork models (e.g., weight updates) from the device 1 704a and the device 2 704b (at block 712). The server 702 may then generate a global model update based on the aggregated weight updates. For instance, the server 702 may perform a federated averaging process as given by:

$${θ}_{t + 1} = G ( \{ {θ}_{t}^{i} \} ) = {\sum }_{i} \frac{{θ}_{t}^{i}}{N} . \qquad ( 5 )$$

In some aspects, in Equation 5, rather than merely dividing by the number of devices N, a mask [symbol] _{M} may be applied (e.g., mask [symbol] _{M} may replace N). The mask [symbol] _{M} may have the same size as the global model θ. Each value of the mask [symbol] _{M} may correspond to the number of devices updating a particular parameter during the iteration t.

After updating the global model θ, the server 702, may, in some aspects, fine-tune the updated global model (at block 714). For instance, the server 702 may further train the updated global model using the server data D by minimizing the loss function given by:

$${θ}_{t + 1} = arg {min}_{θ} L ( θ , D ) . \qquad ( 6 )$$

In various aspects, the fine tuning may be performed using a set of public data such as data of a backup device, for instance. Fine-tuning the updated global model may improve, and in some aspects optimize, a trade-off between the utility of the updated global model on the server data D and the local data on the respective devices (e.g., 702a, 702b). Moreover, the fine-tuning may enable knowledge sharing among the server 702 and devices (e.g., 702a, 702b).

Thereafter, the example process 700 may repeat. For instance, at block 710b, the fine-tuned updated global model (θₜ₊₁) may be quantized according to the quantization levels for the different subnetwork models. The example process 700 may continue to repeat according to design preference or until model convergence is achieved.

Accordingly, in the server quantization-aware federated training approach of FIG. 7, the server 702 performs the model quantization (e.g., floating point quantization or fixed point quantization) independently. That is, the server 702 may perform the model quantization, while the devices (e.g., 704a, 704b) do not. As such, the computational cost (e.g., processor workload, memory consumption, or power consumption) for each of the devices (e.g., 704a, 704b) may be reduced.

One potential drawback of the server quantization-aware federated training approach may be that quantized subnetwork models (e.g., Sᵢ) generated by the server 702 may be biased toward the server data D (e.g., if a distribution shift between the server data D and the data Dⱼ of the devices (e.g., 704a, 704b) becomes large). Because the server 702 performs the model quantization independently, only the server data D may be considered in the quantization process (quantization-aware training).

Accordingly, to address the potential bias, in some aspects, regularization may be performed to reduce data bias in favor of the server (e.g., 702) and improve performance (e.g., accuracy) and utility of the subnetwork models. For instance, a regularization term |θⁱ−Q (θⁱₜ, qᵢ) may be added between the local subnetwork models θⁱ with the quantized subnetwork models Q(θⁱₜ, qᵢ) distributed by the server 702, as follows:

$${θ}_{t + 1}^{i} = arg {min}_{{θ}^{i}} L ( {θ}^{i} , {D}_{i} ) + γ \vert {θ}^{i} - Q ( {θ}_{t}^{i} , {q}_{i} ) \vert \qquad ( 7 )$$

where γ is the regularization parameter.

By applying the regularization parameter γ, data shifts between local model fine-tuning on devices (e.g., 704a, 704b) and the quantized subnetwork models optimized on the server data D may be reduced. Thus, knowledge sharing across the server 702 and the devices (e.g., 704a, 704b) may be smoothened.

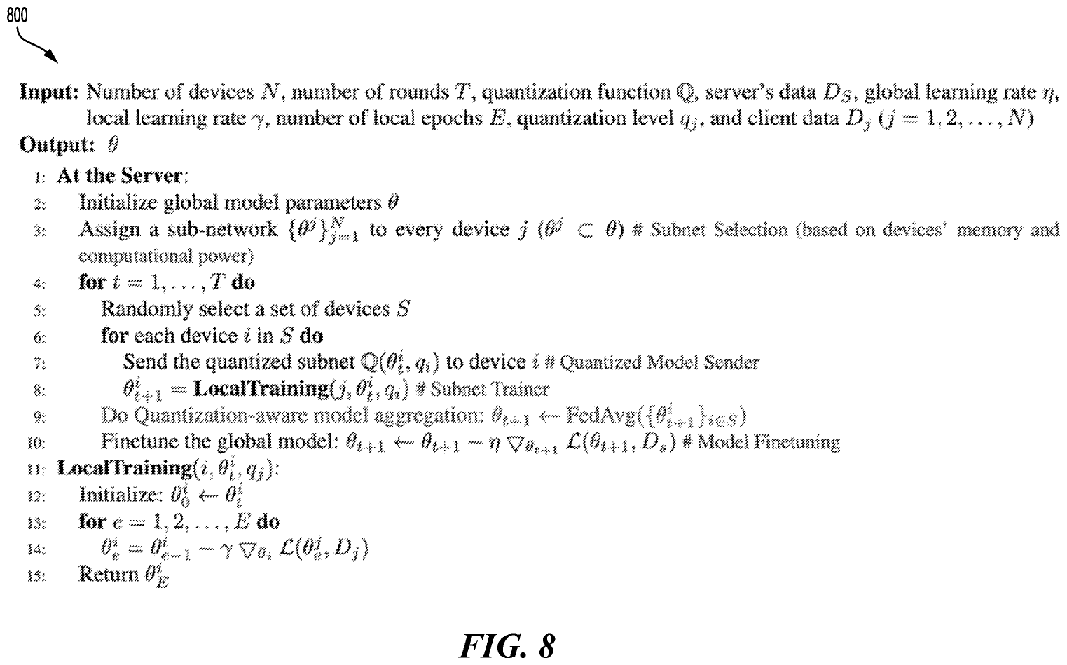

FIG. 8 is a diagram illustrating example pseudocode 800 for server quantization-aware federated training, in accordance with various aspects of the present disclosure. As shown in FIG. 8, at line 2, at the server (e.g., 702), the global model parameters may be initialized. At line 3, each of the devices (e.g., 704a, 704b) may be assigned a subnetwork model of multiple subnetwork models. For instance, the devices (e.g., 704a, 704b) may be assigned a subnetwork model based on the device hardware capabilities (e.g., memory capacity and/or processing capabilities).

At line 4, the quantization-aware federated training may be repeatedly performed by the server (e.g., 702) T times. One or more subnetwork models may be selected for training. As shown in line 5, the subnetwork models may, for example, be randomly selected. The server (e.g., 702) may transmit the quantized subnetwork model to each device (e.g., 704a, 704b) assigned the selected subnetwork model. At line 8, each device (e.g., 704a, 704b) may, in turn, train a local model (as shown at line 11) and may send the updated subnetwork models (e.g., weight updates) to the server (e.g., 702). At line 9, the server (e.g., 702) may aggregate the received updated subnetwork models to generate an updated global model. For example, the updated subnetwork models may be aggregated and averaged (e.g., via a federated averaging process) to generate the updated global model. In some aspects, the updated global model may be fine-tuned (at line 10). Thereafter, the process returns to line 4 and may repeat.

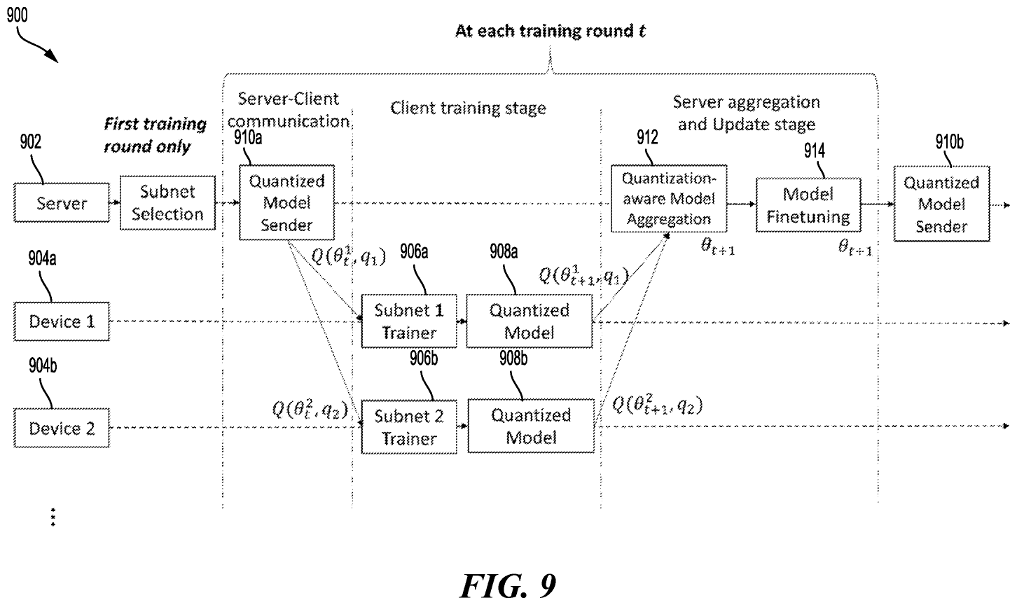

FIG. 9 is a block diagram illustrating an example process 900 for collaborative quantization-aware federated training, in accordance with various aspects of the present disclosure. Referring to FIG. 9, a server 902 may select one or more subnetwork models to train. At each training iteration (e.g., training round t), the server 902 may transmit quantized subnetwork models to the respective devices (e.g., 904a, 904b). That is, the server 902 may generate a quantized global model for each device in which the global model is quantized at a quantization level according to the subnetwork model. As such, the server 902 may distribute the quantized global model Q(θₜ¹, q₁) to a first device (device 1 904a) assigned to a first subnetwork model (subnetwork model 1) and the quantized global model Q(θₜ², q₂) to a second device (device 2 904b) assigned to a second subnetwork model (subnetwork model 2) (at block 910a).

The device 1 904a and device 2 904b may respectively train local quantized subnetwork models (e.g., θₜ₊₁¹, θₜ₊₁²) for subnetwork 1 (at block 906a) and subnetwork 2 (at block 906b). The device 1 904a and the device 2 904b may independently train and update the local subnetwork models using the respective local data by minimizing the loss function as shown in Equation 4.

The device 1 904a and device 2 904b may respectively train local models (e.g., θₜ₊₁¹, θₜ₊₁²) for subnetwork 1 (at block 906a) and subnetwork 2 (at block 906b). The device 1 904a and the device 2 904b may each quantize the respective model parameters (e.g., weights) (at block 908a and 908b). In some aspects, the quantization by the devices (e.g., 904a, 904b) may not be performed in every training round to reduce device computation costs given the resource constraints of the devices (e.g., 904a, 904b).

The devices (e.g., 904a and 904b) may send the quantized subnetwork models back to the server 902. However, if quantization is not performed by the devices (904a, 904b) for a given training round, the devices (904a, 904b) may send the trained subnetwork model back to the server 902.

The server 902 may receive the quantized updated subnetwork models generated by the devices (904a, 904b) for the server 902. In turn, the server 902 may aggregate the quantized updated subnetwork models and generate an updated global model, for instance using a federated averaging process (at block 912). The updated global model may also be fine-tuned to further improve (e.g., increase the accuracy) of the updated global model (at block 914). Then, the server may perform the model quantization and the process may repeat for subsequent training rounds at block 910b.

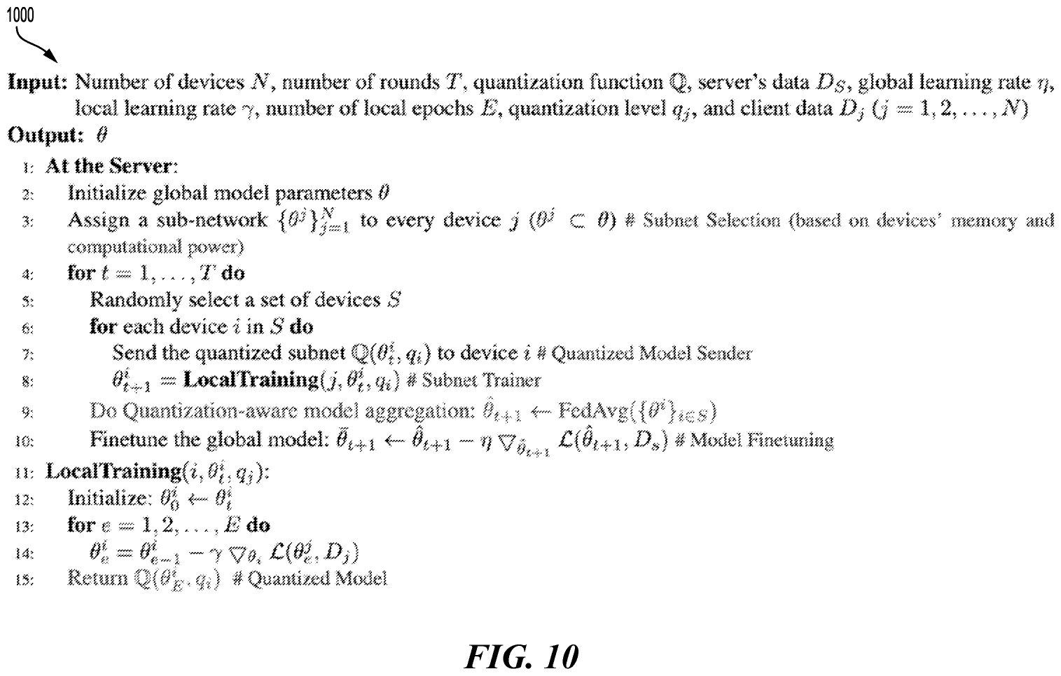

FIG. 10 is a diagram illustrating example pseudocode 1000 for collaborative quantization-aware federated training, in accordance with aspects of the present disclosure. The example pseudocode 1000 of FIG. 10 is similar to the example pseudocode 800 shown in FIG. 8. However, in the example pseudocode 1000, a server (e.g., 902) and the devices (e.g., 904a, 904b) both may perform model quantization. For instance, at line 7, the server (e.g., 902) may send quantized subnetwork models to each of the devices (e.g., 904a, 904b), respectively. In addition, the devices (e.g., 904a, 904b) may also perform the quantization (at line 11) in one or more training rounds. The devices (904a, 904b) may send quantized updated subnetwork models back to the server (e.g., 902), as shown in line 15.

In some aspects, regularization may be performed to reduce data bias toward the server data D or the device data Dᵢ. Because both the server (e.g., 902) and the devices (e.g., 904a, 904b) may perform a portion of the model quantization, the bias may be in favor of the server (e.g., 902) or the devices (e.g., 904a, 904b). Accordingly, regularization may be added into the local training and global training as follows:

$$Global objection function : {θ}_{t + 1} = arg {min}_{θ} L ( θ , D ) + \frac{γ}{N} {\sum }_{i} \vert {θ}^{i} - Q ( θ , {q}_{i} ) \vert , \qquad ( 8 )$$

$$Local objection function : {θ}_{t + 1}^{i} = arg {min}_{{θ}^{i}} L ( {θ}^{i} , {D}_{i} ) + Δ \vert {θ}^{i} - Q ( {θ}_{t}^{i} , {q}_{i} ) \vert , \qquad ( 9 )$$

where Δ is a device regularization parameter.

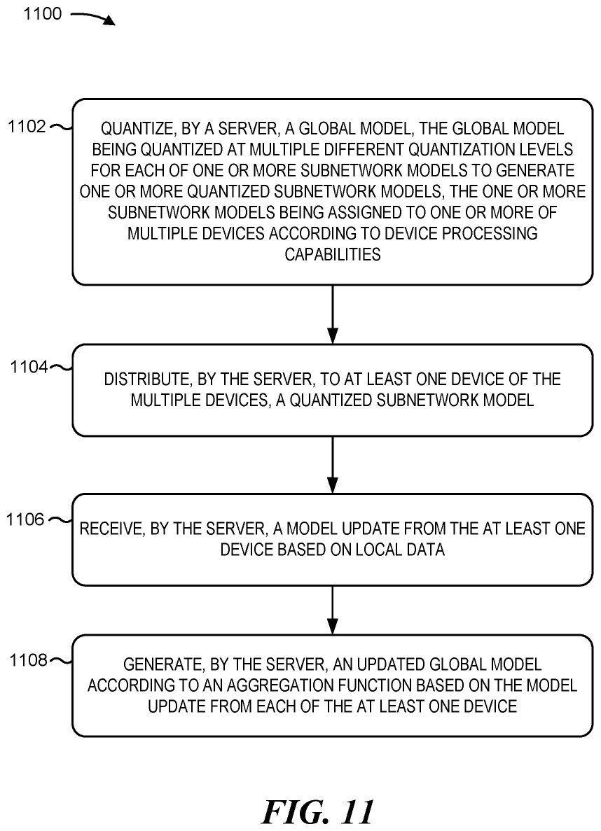

FIG. 11 is a flow diagram illustrating an example processor-implemented method 1100 for server-based quantization-aware federated training, according to aspects of the present disclosure. The processor-implemented method 1100 may be performed by one or more processors, such as the CPU (e.g., 102, 422), GPU (e.g., 104, 426), DSP (e.g., 106, 424), and/or NPU (e.g., 108, 428), for example.

As shown in FIG. 11, at block 1102, the server quantizes a global model. The global model is quantized at multiple different quantization levels for each of one or more subnetwork models to generate one or more quantized subnetwork models. The one or more subnetwork models are assigned to one or more of multiple devices according to device processing capabilities. For instance, as described with reference to FIG. 7, at each training iteration (e.g., training round t′), the server 702 may transmit quantized subnetwork models to the respective devices (e.g., 704a, 704b). The server 702 may generate a quantized global model for each device (e.g., 704a, 704b) in which the global model is quantized at a quantization level according to the subnetwork model.

At block 1104, the server distributes, to at least one device of the multiple devices, a quantized subnetwork model. As described with reference to FIG. 7, the server 702 may distribute the quantized global model Q(θₜ¹, q₁) to device 1 704a assigned subnetwork model 1 and the quantized global model Q(θₜ², q₂) to device 2 704b assigned subnetwork model 2 (at block 710a).

At block 1106, the server receives a model update from the at least one device based on local data. For example, as described with reference to FIG. 7, device 1 704a and device 2 704b may respectively train local quantized subnetwork models (e.g., θₜ₊₁¹, θₜ₊₁²) for subnetwork 1 (at block 706a) and subnetwork 2 (at block 706b). In turn, the device 1 704a and the device 2 704b may transmit respective updated subnetwork models (e.g., weight updates) to the server 702.

At block 1108, the server generates an updated global model according to an aggregation function based on the model update from each of the at least one device. For example, as described with reference to FIG. 7, the server 702 may aggregate the updated subnetwork models (e.g., weight updates) from the device 1 704a and the device 2 704b (at block 712). The server 702 may then generate a global model update based on the aggregated weight updates. In one example, the server 702 may generate the update by performing a federated averaging process with respect to the aggregated model updates. In some aspects, the updated global model may be fine-tuned using public data such as from a backup device having the same device type and processing capabilities, for instance.

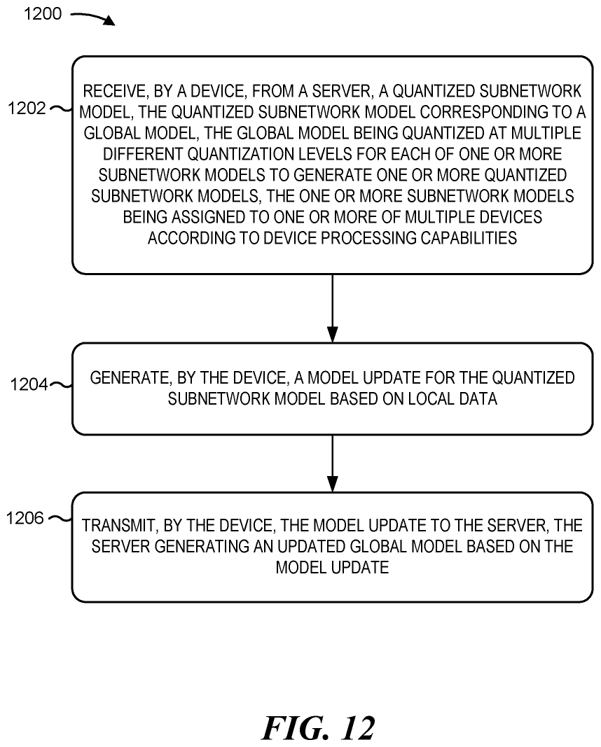

FIG. 12 is a flow diagram illustrating an example processor-implemented method 1200 for collaborative quantization-aware federated training, according to aspects of the present disclosure. The processor-implemented method 1200 may be performed by one or more processors, such as the CPU (e.g., 102, 422), GPU (e.g., 104, 426), DSP (e.g., 106, 424), and/or NPU (e.g., 108, 428), for example.

Referring to FIG. 12, at block 1202, a device receives, from a server, a quantized subnetwork model. The quantized subnetwork model corresponds to a global model. The global model is quantized at multiple different quantization levels for each of one or more subnetwork models to generate one or more quantized subnetwork models. The one or more subnetwork models are assigned to one or more of multiple devices according to device processing capabilities. For instance as described with reference to FIG. 9, the server 902 may distribute a quantized global model Q(θₜ¹, q₁) to a first device (device 1 904a) assigned to a first subnetwork model (subnetwork model 1) and a quantized global model Q(θₜ², q₂) to a second device (device 2 904b) assigned to a second subnetwork model (subnetwork model 2) (at block 910a). The quantized global model Q(θₜ¹, q₁) to a first device (device 1 904a) assigned to a first subnetwork model (subnetwork model 1) and a quantized global model Q(θₜ², q₂) are generated for each device assigned to the respective subnetwork model and the global model is quantized at a quantization level according to the subnetwork model.

At block 1204, the device generates a model update for the quantized subnetwork model based on local data. For instance, as described with reference to FIG. 9, the device 1 904a and the device 2 904b may independently train and update the local subnetwork models using the respective local data by minimizing the loss function as shown in Equation 4.

At block 1206, the device transmits the model update to the server. The server generates an updated global model based on the model update. As described, for example, with reference to FIG. 9, the devices (e.g., 904a and 904b) may send the quantized subnetwork models back to the server 902.

Implementation examples are provided in the following numbered clauses.
1. A processor-implemented method performed by one or more processors, the processor-implemented method comprising:
   quantizing, by a server, a global model, the global model being quantized at multiple different quantization levels for each of one or more subnetwork models to generate one or more quantized subnetwork models, the one or more subnetwork models being assigned to one or more of multiple devices according to device processing capabilities;
   distributing, by the server, to at least one device of the multiple devices, a quantized subnetwork model;
   receiving, by the server, a model update from the at least one device based on local data; and
   generating, by the server, an updated global model according to an aggregation function based on the model update from each of the at least one device.
2. The processor-implemented method of clause 1, further comprising fine-tuning the updated global model using public data of a backup device.
3. The processor-implemented method of clause 1 or 2, further comprising quantizing, by the server, the updated global model at the multiple different quantization levels for each of the one or more subnetwork models to generate one or more quantized updated subnetwork models.
4. The processor-implemented method of any of clauses 1-3, further comprising applying a regularization process to the updated global model to reduce a bias toward server data.
5. The processor-implemented method of any of clauses 1-3, in which the model update from the at least one device is a quantized model update based on a quantization by the at least one device.
6. A processor-implemented method performed by one or more processors, the processor-implemented method comprising:
   receiving, by a device, from a server, a quantized subnetwork model, the quantized subnetwork model corresponding to a global model, the global model being quantized at multiple different quantization levels for each of one or more subnetwork models to generate one or more quantized subnetwork models, the one or more subnetwork models being assigned to one or more of multiple devices according to device processing capabilities;
   generating, by the device, a model update for the quantized subnetwork model based on local data; and
   transmitting, by the device, the model update to the server, the server generating an updated global model based on the model update.
7. The processor-implemented method of clause 6, in which the updated global model is generated using an aggregation function based on the model update by the device.
8. The processor-implemented method of clause 6 or 7, further comprising quantizing, by the device, the model update to generate a quantized model update, the quantized model update being used to generate the updated global model.
9. The processor-implemented method of any of clauses 6-8, further comprising applying a first regularization process to the updated global model to reduce a first bias toward server data or a second regularization process to the quantized model update to reduce a second bias toward device data.
10. The processor-implemented method of any of clauses 6-9, further comprising repeating the receiving, the generating, and the transmitting for multiple training rounds; and in which the quantizing is performed in a subset of the training rounds based on the device processing capabilities.
11. An apparatus, comprising:
   at least one memory; and
   at least one processor coupled to the at least one memory, the at least one processor configured to:
      quantize, by a server, a global model, the global model being quantized at multiple different quantization levels for each of one or more subnetwork models to generate one or more quantized subnetwork models, the one or more subnetwork models being assigned to one or more of multiple devices according to device processing capabilities;
      distribute, by the server, to at least one device of the multiple devices, a quantized subnetwork model;
      receive, by the server, a model update from the at least one device based on local data; and
      generate, by the server, an updated global model according to an aggregation function based on the model update from each of the at least one device.
12. The apparatus of clause 11, in which the at least one processor is further configured to fine-tune the updated global model using public data of a backup device.
13. The apparatus of clause 11 or 12, in which the at least one processor is further configured to quantize, by the server, the updated global model at the multiple different quantization levels for each of the one or more subnetwork models to generate one or more quantized updated subnetwork models.
14. The apparatus of any of clauses 11-13, in which the at least one processor is further configured to apply a regularization process to the updated global model to reduce a bias toward server data.
15. The apparatus of any of clauses 11-14, in which the model update from the at least one device is a quantized model update based on a quantization by the at least one device.
16. An apparatus, comprising:
   at least one memory; and
   at least one processor coupled to the at least one memory, the at least one processor configured to:
      receive, by a device, from a server, a quantized subnetwork model, the quantized subnetwork model corresponding to a global model, the global model being quantized at multiple different quantization levels for each of one or more subnetwork models to generate one or more quantized subnetwork models, the one or more subnetwork models being assigned to one or more of multiple devices according to device processing capabilities;
      generate, by the device, a model update for the quantized subnetwork model based on local data; and
      transmit, by the device, the model update to the server, the server generating an updated global model based on the model update.
17. The apparatus of clause 16, in which the updated global model is generated using an aggregation function based on the model update by the device.
18. The apparatus of clause 16 or 17, in which the at least one processor is further configured to perform a quantization, by the device, the model update to generate a quantized model update, the quantized model update being used to generate the updated global model.
19. The apparatus of any of clauses 16-18, in which the at least one processor is further configured to apply a first regularization process to the updated global model to reduce a first bias toward server data or a second regularization process to the quantized model update to reduce a second bias toward device data.
20. The apparatus of any of clauses 16-19, in which the at least one processor is further configured to: repeat the receiving, the generating and the transmitting for multiple training rounds; and wherein the device performs the quantization in a subset of the training rounds based on the device processing capabilities.

In one aspect, the quantizing means, the distributing means, the receiving means, the generating means, the determining means, and/or transmitting means may be the CPU 102, program memory associated with the CPU 102, the dedicated memory block 118, fully connected layers 362, and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method performed by one or more processors, the processor-implemented method comprising:
quantizing, by a server, a global model, the global model being quantized at multiple different quantization levels for each of one or more subnetwork models to generate one or more quantized subnetwork models, the one or more subnetwork models being assigned to one or more of multiple devices according to device processing capabilities;
distributing, by the server, to at least one device of the multiple devices, a quantized subnetwork model;
receiving, by the server, a model update from the at least one device based on local data; and
generating, by the server, an updated global model according to an aggregation function based on the model update from each of the at least one device.

2. The processor-implemented method of claim 1, further comprising fine-tuning the updated global model using public data of a backup device.

3. The processor-implemented method of claim 1, further comprising quantizing, by the server, the updated global model at the multiple different quantization levels for each of the one or more subnetwork models to generate one or more quantized updated subnetwork models.

4. The processor-implemented method of claim 1, further comprising applying a regularization process to the updated global model to reduce a bias toward server data.

5. The processor-implemented method of claim 1, in which the model update from the at least one device is a quantized model update based on a quantization by the at least one device.

6. A processor-implemented method performed by one or more processors, the processor-implemented method comprising:
receiving, by a device, from a server, a quantized subnetwork model, the quantized subnetwork model corresponding to a global model, the global model being quantized at multiple different quantization levels for each of one or more subnetwork models to generate one or more quantized subnetwork models, the one or more subnetwork models being assigned to one or more of multiple devices according to device processing capabilities;
generating, by the device, a model update for the quantized subnetwork model based on local data; and
transmitting, by the device, the model update to the server, the server generating an updated global model based on the model update.

7. The processor-implemented method of claim 6, in which the updated global model is generated using an aggregation function based on the model update by the device.

8. The processor-implemented method of claim 6, further comprising quantizing, by the device, the model update to generate a quantized model update, the quantized model update being used to generate the updated global model.

9. The processor-implemented method of claim 8, further comprising applying a first regularization process to the updated global model to reduce a first bias toward server data or a second regularization process to the quantized model update to reduce a second bias toward device data.

10. The processor-implemented method of claim 8, further comprising repeating the receiving, the generating, and the transmitting for multiple training rounds; and in which the quantizing is performed in a subset of the training rounds based on the device processing capabilities.

11. An apparatus, comprising:
at least one memory; and
at least one processor coupled to the at least one memory, the at least one processor configured to:
quantize, by a server, a global model, the global model being quantized at multiple different quantization levels for each of one or more subnetwork models to generate one or more quantized subnetwork models, the one or more subnetwork models being assigned to one or more of multiple devices according to device processing capabilities;
distribute, by the server, to at least one device of the multiple devices, a quantized subnetwork model;
receive, by the server, a model update from the at least one device based on local data; and
generate, by the server, an updated global model according to an aggregation function based on the model update from each of the at least one device.

12. The apparatus of claim 11, in which the at least one processor is further configured to fine-tune the updated global model using public data of a backup device.

13. The apparatus of claim 11, in which the at least one processor is further configured to quantize, by the server, the updated global model at the multiple different quantization levels for each of the one or more subnetwork models to generate one or more quantized updated subnetwork models.

14. The apparatus of claim 11, in which the at least one processor is further configured to apply a regularization process to the updated global model to reduce a bias toward server data.

15. The apparatus of claim 11, in which the model update from the at least one device is a quantized model update based on a quantization by the at least one device.

16. An apparatus, comprising:
at least one memory; and
at least one processor coupled to the at least one memory, the at least one processor configured to:
receive, by a device, from a server, a quantized subnetwork model, the quantized subnetwork model corresponding to a global model, the global model being quantized at multiple different quantization levels for each of one or more subnetwork models to generate one or more quantized subnetwork models, the one or more subnetwork models being assigned to one or more of multiple devices according to device processing capabilities;
generate, by the device, a model update for the quantized subnetwork model based on local data; and
transmit, by the device, the model update to the server, the server generating an updated global model based on the model update.

17. The apparatus of claim 16, in which the updated global model is generated using an aggregation function based on the model update by the device.

18. The apparatus of claim 16, in which the at least one processor is further configured to perform a quantization, by the device, the model update to generate a quantized model update, the quantized model update being used to generate the updated global model.

19. The apparatus of claim 18, in which the at least one processor is further configured to apply a first regularization process to the updated global model to reduce a first bias toward server data or a second regularization process to the quantized model update to reduce a second bias toward device data.

20. The apparatus of claim 18, in which the at least one processor is further configured to: repeat the receiving, the generating and the transmitting for multiple training rounds; and wherein the device performs the quantization in a subset of the training rounds based on the device processing capabilities.
